(19) United States
(12) Patent Application Publication
(10) Pub. No.: US 2026/0045679 A1
(43) Pub. Date: Feb. 12, 2026

(54) ELECTRONIC DEVICE

(71) Applicant: HONOR DEVICE CO., LTD., Shenzhen (CN)

(72) Inventors: Xiaoyong Dong, Shenzhen (CN); Hui Yu, Shenzhen (CN)

(21) Appl. No.: 19/364,643

(22) Filed: Oct. 21, 2025

Related U.S. Application Data
(63) Continuation of application No. PCT/CN2024/081907, filed on Mar. 15, 2024.

(30) Foreign Application Priority Data
Jun. 20, 2023 (CN) 202310740807.8

(51) Int. Cl. H01Q 1/24; H01Q 9/04

(52) U.S. Cl. CPC H01Q 1/241; H01Q 9/0414

(57) ABSTRACT

Disclosed is an electronic device. In embodiments of the disclosure, in a case that positions of a first feed terminal and a ground terminal are not changed, a first metal connection arm in embodiments of the disclosure has a middle section arranged with a clearance, and a length of an electric circuit of an antenna formed by a metal frame radiation section is equal to a sum of a length of a section located between a first connection position and a second connection position of the metal frame radiation section and a length of the middle section. By the middle section, a total length of the antenna is increased to a specific extent, and a length of an antenna between the first feed terminal and the ground terminal is increased.

### CROSS-REFERENCE TO RELATED APPLICATIONS

The disclosure is a continuation of International Application No. PCT/CN2024/081907, filed on Mar. 15, 2024, which claims the benefit of priority to Chinese Patent Application No. 202310740807.8, filed on Jun. 20, 2023, both of which are incorporated in their entireties in embodiments of the disclosure by reference.

### TECHNICAL FIELD

Embodiments of the disclosure relate to the technical field of wireless transmission, and in particular, to an electronic device.

### BACKGROUND

An antenna is a significant component of an electronic device for implementing a communication function. Currently, to reduce internal space of the electronic device occupied by the antenna, a metal frame of the electronic device is used as the antenna. The antenna formed by the metal frame is generally referred to as a frame antenna.

During design of the frame antenna, not only types and the quantity of antennas have to be considered to satisfy use demands for the electronic device, but also settings of other related components of the electronic device, for example, shapes and sizes of components such as a battery and a mainboard, have to be taken into account. Thus, the design of the antenna is relatively complex. Especially for a foldable electronic device, due to existence of a rotation shaft of the foldable electronic device, a frame section of the foldable electronic device capable of being used as an antenna has a smaller length, and the frame antenna has relatively high design difficulty.

### SUMMARY

Embodiments of the disclosure provide an electronic device that can increase an electrical length of a metal frame radiation section.

An embodiment of the disclosure provides an electronic device. The electronic device includes a first feed terminal and a ground terminal, and further includes:
a middle frame, where the middle frame includes a metal frame radiation section, and the metal frame radiation section has a first connection position and a second connection position that are configured to be electrically connected to the first feed terminal and the ground terminal respectively; and
a first metal connection arm, where both of at least one group of the first connection position and the first feed terminal, and the second connection position and the ground terminal are electrically connected to each other by the first metal connection arm, and the first metal connection arm has a middle section arranged with a clearance between the middle section and a peripheral metal body. The peripheral metal body includes metal components such as a metal frame of the electronic device and a metal part on a mainboard. The first metal connection arm may be located on a side of the metal frame radiation section facing the mainboard of the electronic device.

Compared with the prior art, in a case that positions of a first feed terminal and a ground terminal are not changed, a first metal connection arm in embodiments of the disclosure has a middle section arranged with a clearance, and an electrical length of an antenna between the first feed terminal and the ground terminal is equal to a sum of a length of a metal section located between a first connection position and a second connection position of the metal frame radiation section and a length of the middle section. By the middle section, a total length of the antenna is increased to a certain extent, and a length of an antenna between the first feed terminal and the ground terminal is increased. In embodiments of the disclosure, by the middle section, a low frequency of an electrical signal radiated by the antenna can be lengthened, and a resonance can be low in an equal matching state. In a case that lengths of metal frame radiation sections are equal to each other, a resonance is low, and a problem that since an electrical length is insufficient in a compact layout, a high resonance is caused and efficiency is reduced is resolved.

In an example, the first connection position and the second connection position are spaced apart from each other in a length direction of the metal frame radiation section. At least a part of a projection of the middle section on the metal frame radiation section is located between the first connection position and the second connection position. In this way, since at least a part of the projection of the middle section on the metal frame radiation section is located between the first connection position and the second connection position, the antenna formed in this way has a relatively compact structure.

In an example, an extension direction of the middle section is consistent with the length direction of the metal frame radiation section. In this way, space in the length direction of the metal frame radiation section can be fully used. The middle section having a great length can be obtained. The electrical length of the antenna formed by the metal frame radiation section can be further increased.

In an example, the middle frame includes an accommodation cavity. The metal frame radiation section includes a side wall facing the accommodation cavity. The side wall includes a first surface and a second surface. The second surface is recessed relative to the first surface towards a side away from the accommodation cavity. A clearance is provided between the middle section and the second surface. The first metal connection arm makes contact with and is electrically connected to the first surface. In an embodiment of the disclosure, an inner side wall (a side wall facing a side of the accommodation cavity is defined as an inner side wall) of the metal frame radiation section is set to be of a recess structure to provide clearance for the middle section. Thus, the middle section can be arranged with a clearance.

In an example, the first metal connection arm includes a first board body. The first board body has a predetermined length in the length direction of the metal frame radiation section. A board surface of the first board body is arranged opposite the side wall. The first board body includes the middle section and a first connection portion that makes contact with and is electrically connected to the first surface. The first connection portion is located on a side of the middle section away from the ground terminal. In an embodiment of the disclosure, the board surface of the first board body is opposite the side wall and extends in the length direction of the metal frame radiation section. In this way, space occupied by the first metal connection arm in a width direction of the middle frame can be reduced as much as possible, and a width of the electronic device can be reduced.

In an example, an end of the middle section away from the first connection portion has a second board body. The second board body is bent towards a side of the accommodation cavity. The second board body has a second connection portion electrically connected to the ground terminal. The second board body may be approximately perpendicular to the first board body. After the second board body is bent, a board surface of the second board body makes contact with the ground terminal. Thus, a connection is relatively convenient.

In an example, the electronic device further includes a mainboard arranged in the accommodation cavity. A board surface of the second board body is opposite a board surface of the mainboard. In this way, space occupied by the second board body in a thickness direction of the electronic device is relatively small, and an ultra-thin design concept of the electronic device is satisfied.

In an example, the first board body further includes a positioning section. The positioning section is connected to a side of the first connection portion away from the middle section. The positioning section is connected and fixed to the side wall of the metal frame radiation section. By the positioning section, an area of the first board body fixed to the metal frame radiation section is further increased, and reliability of the first board body can be improved advantageously. The positioning section may be welded and fixed to the metal frame radiation section.

In an example, the first metal connection arm is connected between the ground terminal and the second connection position. The metal frame radiation section is further provided with a third connection position. The first connection position, the second connection position, and the third connection position are sequentially arranged in a length direction of the metal frame radiation section. The electronic device further includes a second feed terminal. The ground terminal is located between the first feed terminal and the second feed terminal. The electronic device further includes a second metal connection arm. The third connection position is electrically connected to the second feed terminal by the second metal connection arm. Through such a connection, a path of a current circuit of an antenna formed by a section between the first feed terminal and the ground terminal becomes longer, and a length of a current circuit formed by a section between the second feed terminal and the ground terminal of the metal frame radiation section cannot be affected. Moreover, in the embodiment, two or more feed terminals are arranged on a same metal frame radiation section such that the metal frame radiation section can load different electrical signals, and different functional requirements of the electronic device can be satisfied.

In an example, the first metal connection arm is connected and fixed to the second metal connection arm, or the first metal connection arm and the second metal connection arm are of an integrated structure. In an embodiment of the disclosure, the first metal connection arm is connected and fixed to the second metal connection arm. The first metal connection arm and the second metal connection arm may both be independent components, and are fixed to each other through a welding process, an adhesion process, etc. The first metal connection arm and the second metal connection arm as independent components may be separately machined. A machining process is relatively simple.

The first metal connection arm and the second metal connection arm may each be in a form of an antenna metal elastic sheet. The antenna elastic sheet has a simple structure and occupies small space.

In an example, the first metal connection arm includes a positioning section. The positioning section is connected to a side of the first connection portion away from the middle section and extends and is connected to the second metal connection arm. That is, the positioning section is located between the third connection position and the second connection position and connected and fixed to the metal frame radiation section. In this way, fixation reliability of the first metal connection arm can be further improved, and overall intensity of the electronic device can be improved advantageously. The positioning section of the first metal connection arm located between the third connection position and the second connection position may be welded and fixed to the metal frame radiation section.

In an example, the first metal connection arm is welded and fixed to the metal frame radiation section. The second metal connection arm is welded and fixed to the third connection position. The first metal connection arm and the second metal connection arm are both welded and fixed to corresponding positions of the metal frame radiation section through welding. The welding has high connection reliability and occupies small space.

In an example, the first metal connection arm is elastically and electrically connected to the first feed terminal. The second metal connection arm is elastically and electrically connected to the second feed terminal. Through an elastic electric connection, stress on a connection position can be buffered, and service life can be prolonged advantageously. The second metal connection arm may be a metal elastic sheet for an elastic electric connection. The elastic connection has a buffer effect, and can reduce an impact of an external force on a connection position such that connection reliability can be ensured. The first metal connection arm and the second metal connection arm each may be in a form of a metal elastic sheet for an elastic electric connection. The metal elastic sheet is a metal sheet having relatively great elasticity, and has relatively high elasticity of use intensity.

In an example, the middle frame includes a metal frame and a middle metal plate. The metal frame is located on an outer periphery of the middle metal plate. The metal frame radiation section is a partial section of the metal frame. The ground terminal is arranged at the middle metal plate. The electronic device includes the mainboard. The ground terminal is electrically connected to a ground position of the mainboard. The second connection portion of the first metal connection arm is fixedly connected to the ground terminal of the middle metal plate. A connection is convenient. The ground terminal of the middle metal plate may be connected to the ground position of the mainboard through an elastic electric connection.

In an embodiment of the disclosure, the middle section is spaced apart from the middle metal plate and the metal frame radiation section by a preset distance. Thus, the middle metal plate and the metal frame radiation section can be prevented from interfering with signal radiation of the middle section. The middle section may be apart from the middle metal plate and the metal frame radiation section by approximate 1 mm. The middle section may be arranged between the metal frame and the middle metal plate. The ground terminal may be welded and fixed to the middle metal plate. Fixation reliability is relatively high.

In an example, the middle frame further includes a plastic body. The metal frame and the middle metal plate are integrally connected to each other by the plastic body. Thus, on the premise of satisfying a use demand for the electronic device, the plastic body has a relatively light weight, and an overall weight of the electronic device can be reduced advantageously. The metal frame, the middle metal plate, and the plastic body may be integrally formed during an injection molding process.

In an example, the middle frame includes N sides sequentially connected. The metal frame radiation section is located on only one side, or the metal frame radiation section is located on two adjacent sides. Specifically, N is an integer greater than or equal to 2. A shape of the metal frame radiation section can be flexibly set according to use demands.

In an example, the electronic device is a foldable electronic device. The middle frame includes a first middle frame and a second middle frame. The foldable electronic device further includes a rotation shaft. The first middle frame and the second middle frame are rotatably connected to two sides of the rotation shaft respectively. At least one of the first middle frame and the second middle frame has the metal frame radiation section. Each metal frame radiation section and the first feed terminal and the ground terminal that are electrically connected to the metal frame radiation section are all located on a same side of the rotation shaft. In this way, the metal frame radiation section can be connected to the first feed terminal without using a special flexible transmission line to span the rotation shaft. Thus, the structure of the foldable electronic device can be simplified, a thickness of the foldable electronic product can be reduced, and use cost of the foldable electronic device can be reduced. Moreover, space occupied by the antenna in the accommodation cavity of the middle frame can be reduced. Structures of other components of the electronic device can be optimized advantageously. For example, a battery capacity can be increased. Quality of entire device can be further improved.

In an example, the foldable electronic device further includes the mainboard. The mainboard is located in the first middle frame. All metal frame radiation sections that have transmitting functions are centrally arranged in the first middle frame. In this way, a metal frame radiation section connected to a radio frequency circuit of the mainboard may be arranged only at the first middle frame position such that use demands for the foldable electronic device can be satisfied. The metal frame radiation section connected to a radio frequency circuit of the mainboard is not required to be arranged at the second middle frame position such that the structure of the foldable electronic device can be simplified, and an overall structural layout of the foldable electronic device can be optimized.

In an example, the second middle frame has at least one metal frame radiation section. The metal frame radiation section located in the second middle frame has only modulation and/or demodulation functions. In this way, the antenna on the second middle frame is basically a passive antenna, and may be used in cooperation with the antenna on the first middle frame such that radiation performance of the antenna on the first middle frame can be improved.

### BRIEF DESCRIPTION OF DRAWINGS

FIG. 1 shows a radiation principle diagram of a frame antenna;

FIG. 2 is a schematic structural diagram of a frame antenna of an electronic device in the prior art;

FIG. 3 is a schematic structural diagram of a frame antenna of a foldable electronic device in the prior art;

FIG. 4 is a schematic structural diagram of an electronic device according to an embodiment of the disclosure;

FIG. 5 is a schematic structural diagram of an electronic device according to an embodiment of the disclosure;

FIG. 6 is a schematic partial view of the electronic device shown in FIG. 5, where only approximate positions of a middle frame, a rotation shaft, and a mainboard are shown;

FIG. 7 is a partial sectional view of a position C-C in FIG. 5, where only main components are shown;

FIG. 8 is a schematic diagram of the structure shown in FIG. 7 from another angle of view;

FIG. 9 is a schematic structural diagram of the structure shown in FIG. 7 with a mainboard and a fixing bolt hidden;

FIG. 10 is a schematic structural diagram of the structure shown in FIG. 9 with a plastic body hidden;

FIG. 11 is a sectional view of a position E-E in FIG. 10;

FIG. 12 is a working principle diagram of the structure shown in FIG. 7;

FIG. 13 is a simulation diagram of an antenna in an embodiment of the disclosure and

a current antenna;

FIG. 14 is a schematic structural diagram of an electronic device according to another embodiment of the disclosure;

FIG. 15 is a schematic structural diagram of the structure shown in FIG. 14 with a mainboard and a fixing bolt hidden;

FIG. 16 is a schematic diagram of the structure shown in FIG. 15 from another angle of view, where a plastic body is hidden;

FIG. 17 is a sectional view in a direction E′-E′ in FIG. 16;

FIG. 18 is a working principle diagram of the structure shown in FIG. 14;

FIG. 19 is a schematic structural diagram of a first metal connection arm in FIG. 7 and

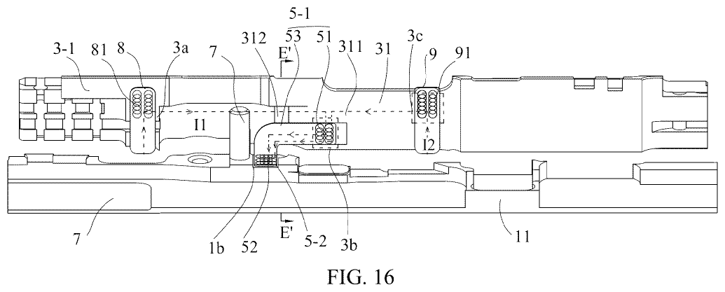

FIG. 16;

FIG. 20 is a schematic diagram of a partial structure of an electronic device according to yet another embodiment of the disclosure;

FIG. 21 is a sectional view in a direction E1-E1 in FIG. 20;

FIG. 22 is a schematic diagram of a partial structure of an electronic device according to yet another embodiment of the disclosure;

FIG. 23 is a schematic structural diagram of the structure shown in FIG. 22 with a plastic body, a mainboard and a fixing bolt removed;

FIG. 24 is a schematic structural diagram of a first metal connection arm in FIG. 22;

FIG. 25 is a schematic diagram of a partial structure of an electronic device according to yet another embodiment of the disclosure;

FIG. 26 is a schematic structural diagram of the structure shown in FIG. 25 with a plastic body, a mainboard and a fixing bolt removed;

FIG. 27 is a schematic structural diagram of a first metal connection arm in FIG. 25;

FIG. 28 is a schematic diagram of a partial structure of an electronic device according to yet another embodiment of the disclosure;

FIG. 29 is a schematic diagram of a partial structure of an electronic device according to the prior art; and

FIG. 30 is a schematic diagram of a partial structure of an antenna according to still another embodiment of the disclosure.

### DESCRIPTION OF EMBODIMENTS

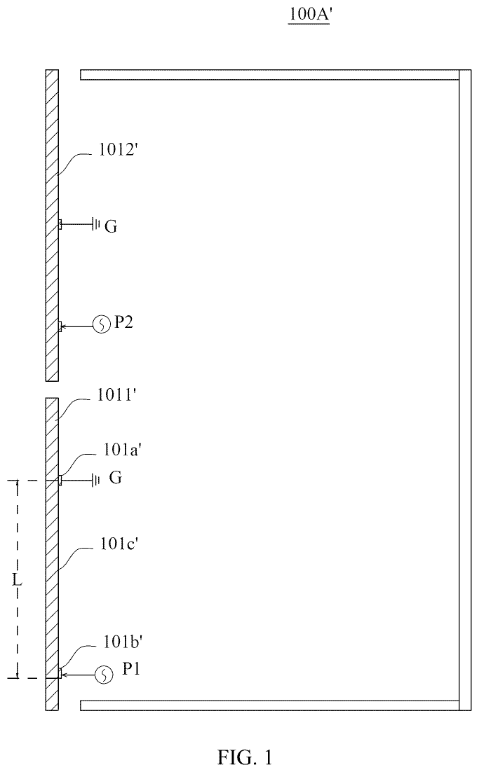

The inventor of the disclosure makes a great deal of researches on the design of a frame antenna of an electronic device. With reference to FIG. 1, a radiation principle diagram of a frame antenna is shown in FIG. 1. FIG. 1 shows two frame antenna sections arranged on a same side of a middle frame 100A′: a first frame section 1011′ and a second frame section 1012′. The first frame section 1011′ and the second frame section 1012′ have a same working principle. In an embodiment of the disclosure, a working principle of an antenna is described with the first frame section 1011′ as an example. The first frame section 1011′ is configured to be electrically connected to a ground point G and a radio frequency circuit P1 by a first connection point 101a′ and a second connection point 101b′ respectively. Since the radio frequency circuit P1 is electrically connected to the first frame section 1011′, when the radio frequency circuit P1 transmits an electrical signal to a metal radiation unit 101c′ located between the first connection point 101a′ and the second connection point 101b′, an electric field and a magnetic field around the metal radiation unit 101c′ between the first connection point 101a′ and the second connection point 101b′ will change. Further, a resonance occurs on the metal radiation unit 101c′, and a radio signal is radiated to the outside. The radio frequency circuit P2 of the second frame section 1012′ may be different from or certainly may be the same as the radio frequency circuit P1 of the first frame section 1011′.

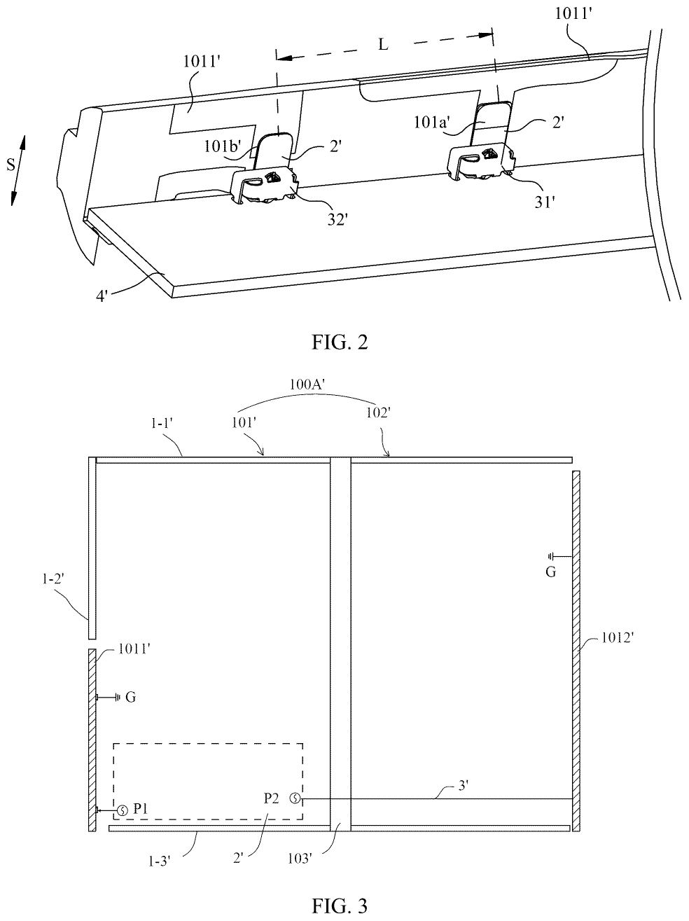

It can be understood in combination with FIG. 2 that a current first connection point 101a′ and second connection point 101b′ are electrically connected to a ground terminal 31 ‘and a feed terminal 32’ that are located right below the first connection point and the second connection point by electrically-conductive reeds 2′ vertically arranged respectively. The feed terminal 32′ is arranged on the mainboard 4′. The electrically-conductive reed 2′ basically makes contact with the first frame section 1011′, the ground terminal 31′, or the feed terminal 32′. Thus, a length L of the metal radiation unit 101c′ determines a radiation frequency band of the frame antenna. The lower the radiation frequency band, the greater L. A section of the middle frame capable of being used as a frame antenna is limited. If a frame antenna having a relatively low radiation frequency band is arranged, a size of the middle frame 100A′ capable of being used for other radiation frequency bands is certainly less. To satisfy use demands for electronic devices having a plurality of radiation frequency bands, when frame antennas are arranged currently, a frame antenna having a low radiation frequency band is generally canceled. In this case, use function demands for the electronic devices are limited to a certain extent.

Particularly, a layout of the frame antenna more prominently affects parameters of the entire foldable electronic device. With reference to FIG. 3, a current foldable electronic device includes a middle frame 100A′ and a rotation shaft 103′. The middle frame 100A′ includes two parts: a first middle frame 101′ and a second middle frame 102′. The first middle frame 101′ and the second middle frame 102′ are arranged on two sides of the rotation shaft 103′, and can be relatively folded or unfolded by the rotation shaft 103′. Due to an arrangement of the rotation shaft of the foldable electronic device, the first middle frame 101′ can be provided, on only three sides: a first side 1-1′, a second side 1-2′, and a third side 1-3′, with radiation sections. To satisfy requirements of various antenna functions of the foldable electronic device, radiation sections are required to be arranged in both the first middle frame 101′ and the second middle frame 102′ currently. FIG. 3 shows that the first middle frame 101′ is provided with a first radiation section 1011′, and the second middle frame 102′ is provided with a second radiation section 1012′. Moreover, the mainboard 2′ is generally arranged on a side of the first middle frame 101′. A radio frequency circuit of each radiation section is located on the mainboard 2′. For example, in FIG. 3, a first radio frequency circuit P1 and a second radio frequency circuit P2 are both located on the mainboard 2′. The first radio frequency circuit P1 and the second radio frequency circuit P2 provide electrical signals for the first radiation section 1011′ and the second radiation section 1012′ respectively. The electric signal of the second radio frequency circuit P2 is required to be transmitted to the second radiation section 1012′ by a transmission line 3′. The transmission line 3′ passes through a region in which the rotation axis 103′ is located. Since the transmission line 3′ is required to be repeatedly unfolded and folded in cooperation with the rotation axis 103′, the transmission line 3′ is required to be made of a special material, such as, polyimide (P1), modified polyimide (MPI), and liquid crystal polymer (LCP). The transmission line 3′ made of a special flexible material has a relatively high price, resulting in relatively high cost of a foldable electronic device. Moreover, the transmission line 3′ made of a special flexible material has a thickness greater than a thickness of a conventional flexible printed circuit (FPC), and occupies relatively large space. Thus, a thickness of the entire device will be increased, and a battery capacity is limited. Further, performance parameters of the entire device will be affected.

Based on the above researches and discoveries, the inventor of the disclosure makes explorations and performs lots of experiments to provide an electronic device. The electronic device can satisfy use demands for a plurality of radiation frequency bands as much as possible, use flexibility is relatively high, and quality of the entire device is relatively high.

To enable a person skilled in the art to understand the technical solutions of embodiments of the disclosure more clearly, the embodiments of the disclosure will be described in detail below in combination with accompanying drawings and particular embodiments.

An embodiment of the disclosure relates to an electronic device 100. The electronic device 100 may include a handheld device, an onboard device, a wearable device, a terminal device, or another processing device connected to a wireless modem, and may further include a cellular phone, a smart phone, a personal digital assistant (PDA) computer, a tablet computer, a handheld computer, a laptop computer, a video camera, a video recorder, a camera, a smart watch, a smart wristband, an augmented reality (AR) device, a virtual reality (VR) device, an onboard computer, and other terminal devices having imaging functions. Specific forms of the above terminal devices are not specially limited in embodiments of the disclosure. For ease of understanding, an example in which the electronic device is a mobile phone will be taken below for description.

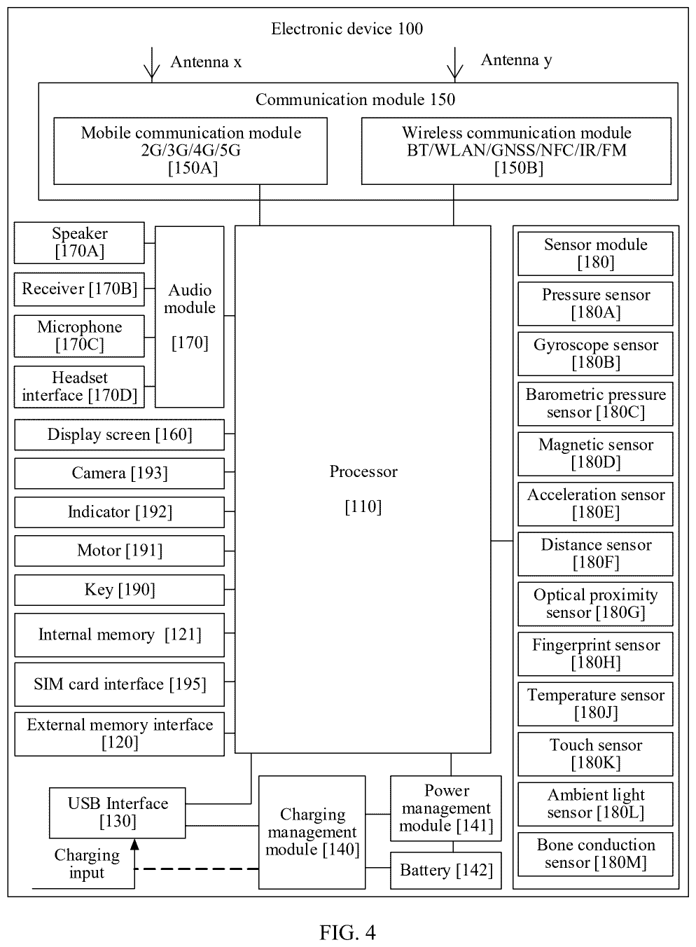

With reference to FIG. 4, a schematic structural diagram of an electronic device according to an embodiment of the disclosure is shown in FIG. 4.

The electronic device 100 in an embodiment of the disclosure may include a processor 110, an internal memory 121, a charging management module 140, a power management module 141, a battery 142, an antenna x, an antenna y, a communication module 150, a display screen 160, an audio module 170, a speaker 170A, a receiver 170B, a microphone 170C, a sensor module 180, a key 190, a motor 191, an indicator 192, a camera 193, etc.

The processor 110 may include one or more processing units. For example, the processor 110 may include an application processor (AP), a modem, a graphics processing unit (GPU), an image signal processor (ISP), a controller, a memory, a video stream codec, a digital signal processor (DSP), a baseband processor, a neural-network processing unit (NPU), etc. Different processing units may be independent devices, or may be integrated to one or more processors.

The processor 110 may have one or more interfaces. The interface may include but is not limited to a universal serial bus (USB) interface 130, a headset interface 170D, an SIM card interface 195, an external memory interface 120, and the USB interface 130.

The communication module 150 may include an antenna x, an antenna y, and a mobile communication module 150A and/or a wireless communication module 150B. FIG. 1 shows an example in which the communication module 150 includes both a mobile communication module 150A and a wireless communication module 150B. The antenna x is coupled to the mobile communication module 150A. The antenna y is coupled to the wireless communication module. Communication of the electronic device may be implemented by the communication module 150, the modem, the baseband processor, etc.

The antenna x and the antenna y may both have functions of transmitting and receiving electromagnetic wave signals. Each antenna of the electronic device is configured to cover one or more communication frequency bands. Different antennas may be multiplexed such that a utilization rate of the antennas can be increased. For example, the antenna x may be multiplexed as a diversity antenna in a wireless local area network. In some other embodiments, the antenna may be used in combination with a tuning switch.

The mobile communication module 150A may provide a solution applied to the electronic device for wireless communication including 2G/3G/4G/5G, etc. The mobile communication module 150A may include at least one filter, switch, power amplifier, low noise amplifier, etc. The mobile communication module 150A may receive an electromagnetic wave by the antenna x, filter and amplify the received electromagnetic wave, etc., and transmit the electromagnetic wave to the modem for demodulation. The mobile communication module 150A may further amplify a signal obtained after modulation by the modem, and convert the amplified signal into an electromagnetic wave by the antenna x for radiation.

The modem may include a modulator and a demodulator. The modulator is configured to modulate a to-be-transmitted low-frequency baseband signal into a medium-high-frequency signal. The demodulator is configured to demodulate the received electromagnetic wave signal into a low-frequency baseband signal. Then, the demodulator transmits the low-frequency baseband signal obtained through demodulation to the baseband processor for processing. The low-frequency baseband signal is processed by the baseband processor and then transferred to the application processor. The application processor outputs a sound signal by an audio device (not limited to the above speaker 170A, receiver 170B, etc.), or displays an image or a video stream by the display screen 160.

The wireless communication module 150B may provide a solution applied to the electronic device for wireless communication including a wireless local area network (WLAN), Bluetooth (BT), a global navigation satellite system (GNSS), frequency modulation (FM), a near field communication (NFC) technology, an infrared (IR) technology, etc. The wireless communication module 150B receives an electromagnetic wave by the antenna y, modulates a frequency of an electromagnetic wave signal, filters the electromagnetic wave signal, and transmits the processed signal to the processor 110. The wireless communication module 150B may further receive a to-be-transmitted signal from the processor 110, modulate a frequency of the to-be-transmitted signal, amplify the to-be-transmitted signal, and convert the to-be-transmitted signal to an electromagnetic wave by the antenna for radiation.

In an embodiment of the disclosure, the sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, etc. to sense and/or acquire different signals.

Schematic structures in embodiments of the disclosure do not constitute specific limitations to the electronic device 100. In some other embodiments, the electronic device 100 may include more or fewer components than those shown in FIG. 4, combine some components, split some components, or differently arrange components. The components shown in the figures may be implemented as hardware, software, or their combinations.

The electronic device provided in an embodiment of the disclosure will be introduced below. Technical solutions and technical effects will be continuously introduced with an example in which the electronic device is a foldable electronic device.

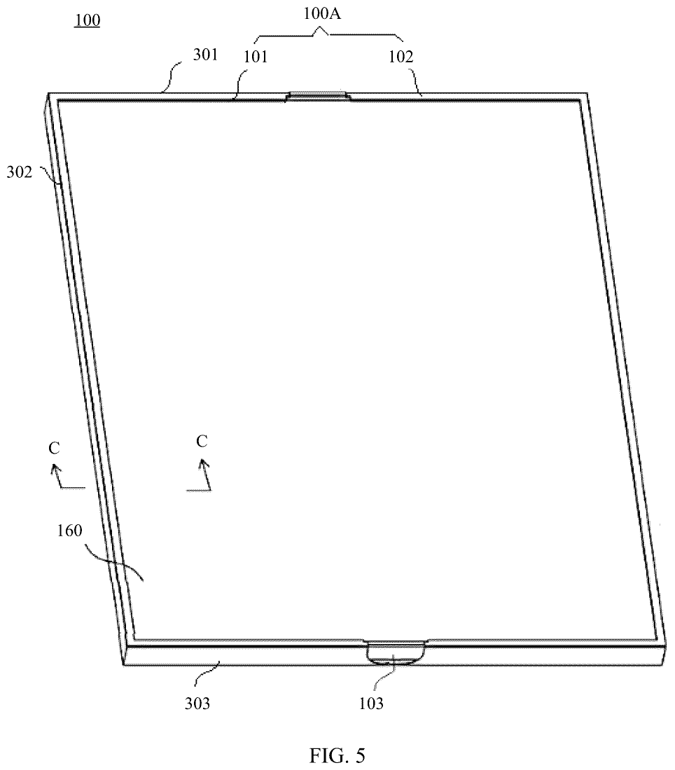

With reference to FIG. 5, a schematic structural diagram of a foldable electronic device according to an embodiment of the disclosure is shown in FIG. 5.

The foldable electronic device in an embodiment of the disclosure includes a middle frame 100A and a rotation shaft 103. The middle frame 100A includes two parts: a first middle frame 101 and a second middle frame 102. The first middle frame 101 and the second middle frame 102 are located on two sides of the rotation shaft 103 respectively. The first middle frame 101 is connected to the second middle frame 102 by the rotation shaft 103. Under an action of the rotation shaft 103, the first middle frame 101 and the second middle frame 102 can be relatively folded or unfolded such that the foldable electronic device can be folded or unfolded. Electronic devices such as the processor 110, the internal memory 121, the charging management module 140, the power management module 141, and the battery 142 mentioned above are mounted in the first middle frame 101 and the second middle frame 102. The display screen 160 is arranged on a side of the first middle frame 101 and the second middle frame 102.

In an embodiment of the disclosure, the second middle frame 102 and the first middle frame 101 may have the same structure or certainly may have a not completely same structure. Specific structures of the two middle frames may be stabilized according to a specific product.

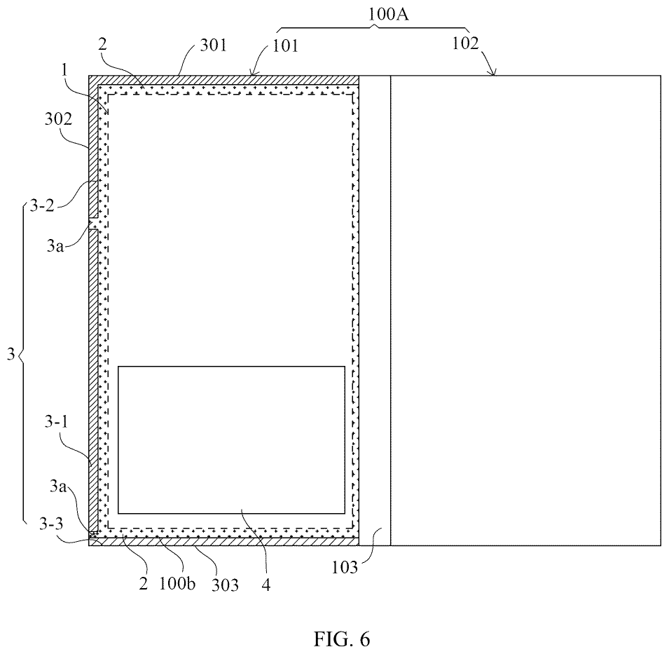

With reference to FIG. 6, a schematic structural diagram only showing approximate positions of the first middle frame, the second middle frame, the rotation shaft, and the mainboard in FIG. 5 is shown in FIG. 6. A dashed line approximately shows a middle metal plate 1.

In an embodiment of the disclosure, the first middle frame 101 may include a middle metal plate 1, a metal frame 3, and a plastic body 2. Approximate positions of the middle metal plate, the metal frame, and the plastic body are shown in FIG. 6. The metal frame 3 is located on a periphery of the middle metal plate 1. In the foldable electronic device, the middle metal plate 1 has no metal frame 3 on a side of a position of the rotation shaft 103. That is, in a case of a rectangular first middle frame 101, the metal frame 3 includes three sides: a first side 301, a second side 302, and a third side 303. The metal frame 3 is located on a periphery of the middle metal plate 1. The middle metal plate 1 is located in space delimited by the metal frame 3 and the rotation shaft 103. The middle metal plate 1 may support components such as the mainboard 4 of the foldable electronic device and the above camera 193. The mainboard 4 herein may be a partial structure of the above processor 110. The first middle frame 101 has an accommodation cavity 100b. Components such as the mainboard 4 are mounted in the accommodation cavity 100b.

In an embodiment of the disclosure, the mainboard 4 of the electronic device 100 may be arranged in the first middle frame 101. The first middle frame 101 is used as a main frame of the electronic device. Radio frequency circuits of various antennas are arranged on the mainboard 4. At least a partial section of the metal frame 3 of the first middle frame 101 may be used as an active antenna. A side of the second middle frame 102 is provided with no antenna or only a modulation or/and demodulation antenna. A function of modulation is to convert various digital baseband signals into digital modulation signals (modulated signals or frequency band signals) suitable for channel transmission. A function of demodulation is to restore, at a receiving end, the received digital band signals to digital baseband signals. The antenna formed by the metal frame radiation section provided in an embodiment of the disclosure can be used for both a radio frequency circuit and a modulation and demodulation circuit.

With reference to FIG. 6, in an embodiment of the disclosure, the metal frame 3 of the first middle frame 101 has a metal frame radiation section 3-1. The metal frame radiation section 3-1 is disconnected from another section of the metal frame 3 by a breakpoint 3a. FIG. 6 shows that the metal frame radiation section 3-1 is located at a second side edge 302 of the metal frame 3. In addition to the metal frame radiation section 3-1, the metal frame 3 further includes a first section 3-2 and a second section 3-3. A breakpoint 3a is provided between the metal frame radiation section 3-1 and the first section 3-2. A breakpoint 3a is provided between the metal frame radiation section 3-1 and the second section 3-3. Certainly, according to an actual requirement of the electronic device, the first section 3-2 and the second section 3-3 may be used as frame antennas. That is, the metal frame radiation section 3-1 in the disclosure may be located only on one side of the first middle frame 101, or certainly may be located on adjacent two sides. A quantity of sides of the first middle frame 101 is not limited to 3 shown in an embodiment of the disclosure. The first middle frame 101 may have N sides sequentially connected. Specifically, N is an integer greater than or equal to 2. For example, N may be 3, 4, 5, or an integer greater than 5.

In a case of a non-foldable electronic device, a quantity of sides of the middle frame 100A may be an integer greater than or equal to 2. The metal frame radiation section 3-1 may be located only on one side of the first middle frame 101, or certainly may be located on adjacent two sides.

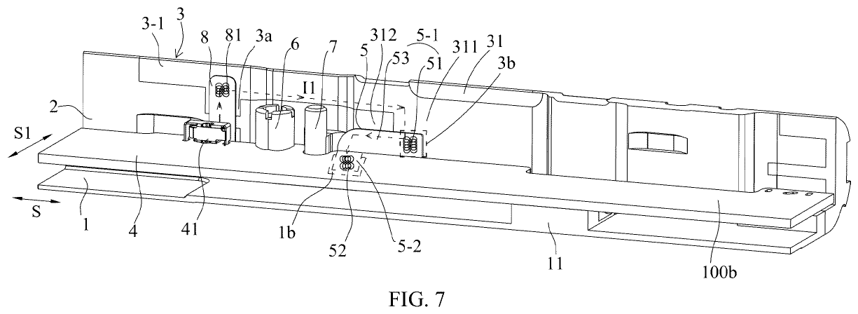

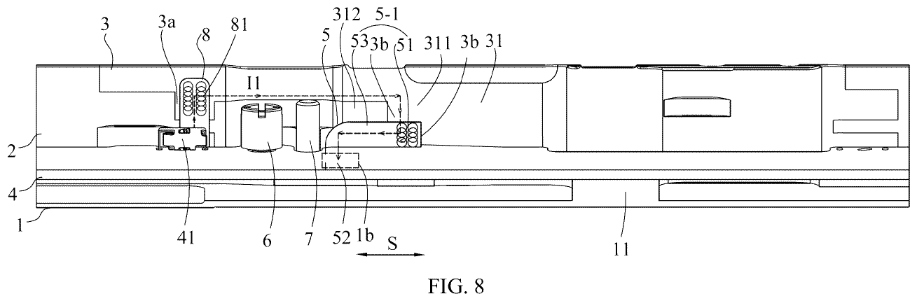

With reference to FIG. 7 and FIG. 8, a partial sectional view of a position C-C in FIG. 5 is shown in FIG. 7. Only main components of the structure in FIG. 7 are shown. FIG. 8 is a schematic structural diagram in another direction of FIG. 7.

FIG. 7 shows that a support table 11 is arranged on the middle metal plate 1 and can support the mainboard 4. In addition, a positioning post 7 and a fixing bolt 6 may be fixed to the middle metal plate 1. The positioning post 7 is configured to mount and position the mainboard 4 when the mainboard is assembled. The mainboard 4 may be fixedly connected to the middle metal plate 1 by the fixing bolt 6. Moreover, the mainboard 4 may be grounded by the fixing bolt 6. In an embodiment of the disclosure, the metal frame 3 and the middle metal plate 1 may be separately arranged, and are integrally formed by the plastic body 2. Since the metal frame 1 and the middle metal plate 3 are integrally formed by the plastic body 2, a forming method is simple. Moreover, on the premise of satisfying use intensity, the middle frame 100A has a relatively light weight. The metal frame 3 and the middle metal plate 1 may be partially separately arranged. For example, only a frame section of the metal frame 3 used as an antenna and the middle metal plate 1 are separately arranged, and a frame section not used as an antenna may be connected to the middle metal body 1. In this way, overall strength of the middle frame 100A can be improved to a certain extent. Certainly, the metal frame 3 and the middle metal plate 1 may be completely separately arranged.

With reference to FIG. 7 and FIG. 8 again, in an embodiment of the disclosure, the antenna of the electronic device includes a metal frame radiation section 3-1 and a first metal connection arm 5. As shown in FIG. 6, the metal frame radiation section 3-1 is a part of the metal frame 3. The metal frame 3 may have one or more metal frame radiation sections 3-1. With reference to FIG. 7, the metal frame radiation section 3-1 includes a first connection position 3a and a second connection position 3b. The first connection position 3a and the second connection position 3b may be electrically connected to a first feed terminal 41 and a ground terminal 1b respectively. The first feed terminal 41 may be connected to a first radio frequency circuit of the mainboard 4 by a transmission line. That is, the first feed terminal 41 may be a radio frequency feed terminal. When the metal frame radiation section 3-1 is electrically connected to the first radio frequency circuit, the metal frame radiation section 3-1 may be used as a transmitting antenna. Certainly, the first feed terminal 41 may be electrically connected to the first modulation and demodulation circuit of the mainboard 4. That is, the first feed terminal 41 may be a modulation and demodulation signal feed terminal. The structure of the radio frequency feed terminal is approximately the same as the structure of the modulation and demodulation signal feed terminal. The ground terminal 1b is located on the middle metal plate 1. The ground terminal 1b may be electrically connected to a corresponding ground position of the mainboard 4 by a feed line or a metal elastic sheet. The ground terminal 1b may be welded and connected to the middle metal plate 1 through welding.

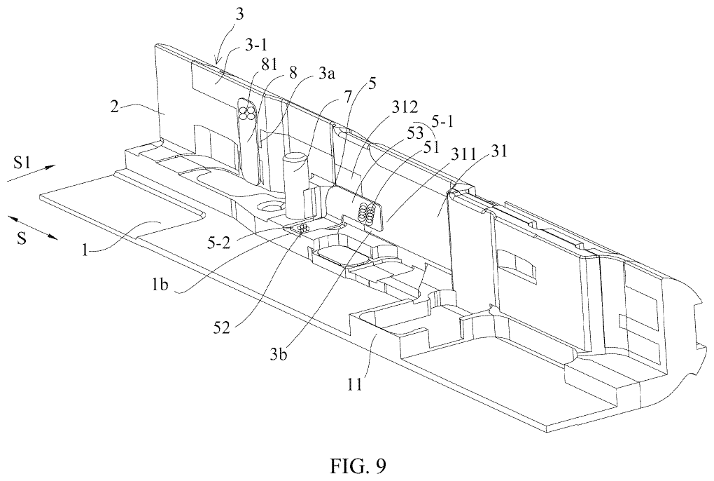

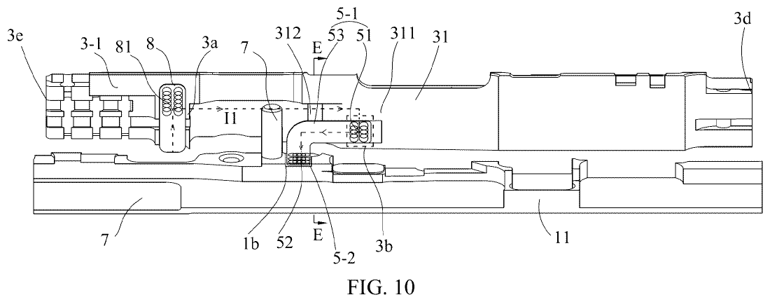

It can be understood in combination with FIG. 9 and FIG. 10 that a schematic diagram of the structure shown in FIG. 7 with a mainboard and a fixing bolt removed is shown in FIG. 9, and a schematic structural diagram of the structure shown in FIG. 9 with a plastic body removed is shown in FIG. 10. The electronic device in an embodiment of the disclosure includes a first feed terminal 41 and a ground terminal 1b. The metal frame radiation section 3-1 has a first connection position 3a and a second connection position 3b. The first connection position 3a is electrically connected to the first feed terminal 41. The second connection position 3b is electrically connected to the ground terminal 1b. A section of the metal frame radiation section 3-1 located between the first connection position 3a and the second connection position 3b is connected to a current circuit between the first feed terminal 41 and the ground terminal 1b.

In an embodiment of the disclosure, both of at least one group of the first connection position 3a and the first feed terminal 41, and the second connection position 3b and the ground terminal 1b are electrically connected to each other by a first metal connection arm 5. In an embodiment of the disclosure, the first metal connection arm 5 is connected between the second connection position 3b and the ground terminal 1b. A corresponding position of the metal frame radiation section 3-1 may be fixedly connected to the first metal connection arm 5 through welding. The first metal connection arm 5 has a middle section 53. The middle section 53 is arranged with a clearance between the middle section and a peripheral metal body of the electronic device. A clearance setting means that a preset gap is provided between the middle section 53 and the peripheral metal body. A size range of the preset gap is as follows: the standard is that radiation work of the middle section 53 is not affected, or that even an impact exits, the impact is within a required range. The peripheral metal body includes metal components such as a metal frame 3, a middle metal plate 1, and a mainboard 4 of the electronic device.

With reference to FIG. 7 to FIG. 10 again, in an embodiment of the disclosure, the first metal connection arm 5 includes two connection portions. The two connection portions are respectively defined as: a first connection portion 51 and a second connection portion 52. A middle section 53 is connected between the first connection portion 51 and the second connection portion 52. In an embodiment of the disclosure, the second connection position 3b and the ground terminal 1b are fixedly connected to the first connection portion 51 and the second connection portion 52 of the first metal connection arm 5 respectively.

In an embodiment of the disclosure, the first connection portion 51 and the second connection portion 52 are spaced apart from each other in a length direction S of the metal frame radiation section 3-1. A distance between the first connection portion and the second connection portion that are spaced apart from each other in the length direction S of the metal frame radiation section 3-1 is determined according to a requirement of a specific product for an antenna length. In an embodiment of the disclosure, the distance between the first connection position 3a and the second connection position 3b that are spaced apart from each other in the length direction of the metal frame radiation section 3-1 is determined according to a requirement of a specific product for an antenna length.

With reference to FIG. 7 to FIG. 10, when the first metal connection arm 5 is connected between the second connection position 3b and the ground terminal 1b, since the first connection portion 51 and the second connection portion 52 are spaced apart from each other in the direction S, the second connection position 3b and the ground terminal 1b are also spaced apart from each other in the length direction of the metal frame radiation section 3-1. In an embodiment of the disclosure, the first connection position 3a is electrically connected to the first feed terminal 41 by a metal elastic sheet 8. The metal elastic sheet 8 has a straight plate structure. The metal elastic sheet 8 has a welding region 81 and is welded and fixed to the first connection position 3a. A lower end of the metal elastic sheet 8 elastically abuts against and is electrically connected to the first feed terminal 41.

Certainly, the structure of the metal elastic sheet 8 is not limited to the above descriptions of implementations of the disclosure. Other structures are available as long as the first connection position 3a can be electrically connected to the first feed terminal 41.

The metal frame radiation section 3-1 may be a straight line section. An embodiment of the disclosure shows a particular example in which the metal frame radiation section 3-1 is approximately a straight line section. Specifically, S indicates a length direction of the metal frame radiation section 3-1. Certainly, the metal frame radiation section 3-1 may be a curve section.

In an embodiment of the disclosure, the first connection portion 51 and the second connection portion 52 are spaced apart from each other in the extension direction of the metal frame radiation section 3-1. Thus, the middle section 53 can favorably extend in the direction S, and space in the length direction of the metal frame radiation section 3-1 can be fully used. In this way, a relatively long middle section 53 can be obtained, and the electrical length of the antenna can be further increased.

The first connection position 3a and the second connection position 3b are also spaced apart from each other in the length direction S of the metal frame radiation section 3-1. At least a part of a projection of the middle section 53 on the metal frame radiation section 3-1 is located between the first connection position 3a and the second connection position 3b. In this way, since at least a part of the projection of the middle section 53 on the metal frame radiation section 3-1 is located between the first connection position 3a and the second connection position 3b, the antenna formed in this way has a relatively compact structure.

In an example, the metal frame radiation section 3-1 further includes a side wall 31 facing a side of the rotation shaft 103 or the mainboard 4. Certainly, the side wall 31 also faces the accommodation cavity 100b of the middle frame 100A. The side wall 31 includes a first surface 311 and a second surface 312. The second surface 312 relative to the first surface 311 is recessed towards a side away from the mainboard 4. A predetermined gap is formed between the middle section 53 and the second surface 312. The first connection portion 52 makes contact with and is electrically connected to the first surface 311.

In the above embodiment, a recessed section is arranged on the side wall 31 of the metal frame radiation section 3-1 facing the first metal connection arm 5 to satisfy a requirement of a clearance between the middle section 53 and the metal frame radiation section 3-1. During radiation work, mutual interference between the middle section and the metal frame radiation section is reduced. This arrangement method is relatively simple, and a size of the first middle frame 101 in a direction S1 can be reduced as much as possible.

To improve overall use intensity of the first middle frame 101, the recessed position of the second surface 312 may be properly filled with a plastic body 2.

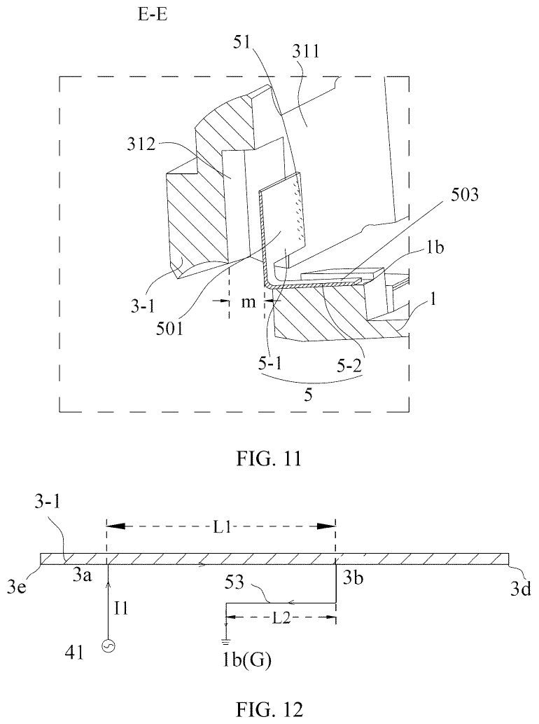

With further reference to FIG. 11, a sectional view of a portion E-E of the structure shown in FIG. 10 is shown in FIG. 11. FIG. 11 shows that a predetermined gap m is provided between the middle section 53 and the metal frame radiation section 3-1 in a direction S1. The standard of the predetermined gap m is that the middle section 53 and the metal frame radiation section 3-1 do not affect each other during radiation work, or even though the middle section and the metal frame radiation section affect each other, the impact is within a required range. In a particular example, the predetermined gap m is approximately 1 mm.

In an embodiment of the disclosure, after the middle section 53 of the first metal connection arm 5 is arranged with a clearance, when the antenna works, a path of a current I1 can be obtained with reference to FIG. 12. A total length of the antenna connected between the first feed terminal 41 and the ground terminal 1b is as follows: L′=L1+L2. Specifically, L1 is a length of a section of the metal frame radiation section 3-1 located between the first connection position 3a and the second connection position 3b, and L2 is a length of the middle section 53.

It can be understood in combination with FIG. 9 and FIG. 12 that the metal frame radiation section 3-1 further has a first terminal 3e and a second terminal 3d. When the antenna formed by the metal frame radiation section 3-1 and the first metal connection arm 5 work, a section of the metal frame radiation section 3-1 located between the first connection position 3a and the second connection position 3b has a main radiation function. A section located between the first connection position 3a and the first terminal 3e and a section located between the second connection position 3b and the second terminal 3d can also have a radiation function according to requirements of radiation frequency bands.

Compared with the prior art, in a case that positions of the first feed terminal 41 and the ground terminal 1b are unchanged or positions of the first connection position 3a and the second connection position 3b of the first metal connection arm 5 are unchanged, embodiments of the disclosure have features as follows: the first metal connection arm 5 has a middle section 53 arranged with a clearance. An electrical length of the antenna is equal to a sum of a length of a metal section of the metal frame radiation section 3-1 and located between the first connection position 3a and the second connection position 3b and a length of the middle section 53. Compared with the prior art, the electrical length is increased by approximate 2 times L2. That is, by the middle section 53, the electrical length of the antenna is increased to a certain extent, and the length of the antenna connected between the first feed terminal 41 and the ground terminal 1b is increased. In embodiments of the disclosure, a low frequency can be lengthened by the middle section 53, and a resonance can be low in an equal matching state. In a case that lengths of the metal frame radiation sections 3-1 are equal to each other, an antenna formed by the metal frame radiation section 3-1 and the first metal connection arm 5 provided in the disclosure has a low resonance. A problem that since an electrical length is insufficient in a compact layout, a high resonance is caused and efficiency is reduced is resolved.

In an embodiment of the disclosure, in a case that the antenna is used as a low-band antenna. In working frequency bands of 703 MHz to 960 MHz, a performance of the antenna in an embodiment of the disclosure may be improved by 0.5 dB. In a case that working frequency bands of an antenna are 1.7 GHz to 2.69 GHz, compared with the prior art, an embodiment of the disclosure has beneficial effects that a performance of the antenna can be improved by approximate 0.5 dB. Certainly, working frequency bands of the antenna include but are not limited to the above working frequency bands. The antenna in an embodiment of the disclosure may be extended in more forms according to different use environments. Performances of different frequency bands can be controlled to be improved by increasing or decreasing the length of the middle section 53. Thus, a coverage range of working frequency bands of 0.5 GHz to 6 GHz can be reached. Specifically, 1 GHZ=1000 MHz.

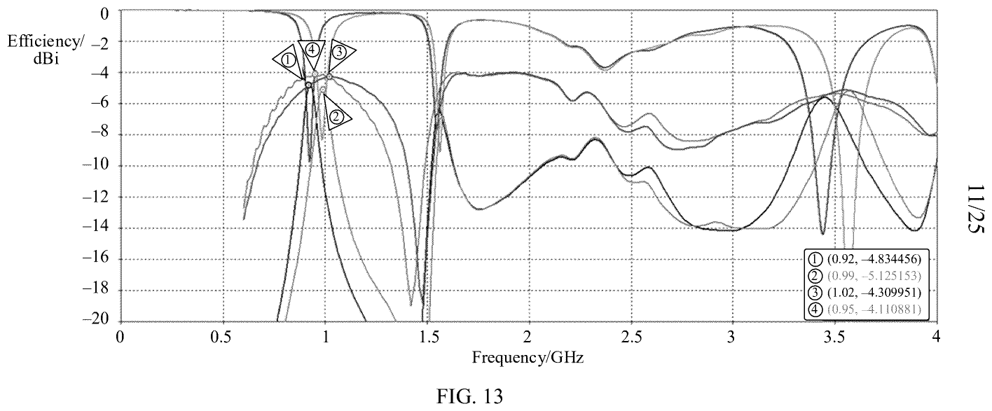

FIG. 13 provides a simulation diagram of an antenna in an embodiment of the disclosure and an antenna in the prior art. An abscissa represents a frequency, and an ordinate represents efficiency.

Under the conditions that other parameters are the same and only the structure of the first metal connection arm 5 is different, it can be seen from the figure that annotation \textcircled{1} indicates a resonance frequency of the antenna in an embodiment of the disclosure, and a value of the resonance frequency is 0.92 GHZ. Annotation \textcircled{2} indicates a resonance frequency of a frame antenna in a currently existing solution, and a value of the resonance frequency is 0.990 GHZ. Apparently, the resonance frequency of the antenna in an embodiment of the disclosure gains 70 MHZ.

Annotation \textcircled{3} in the figure indicates peak efficiency of the current existing frame antenna, and a value of the peak efficiency is −4.3 dBi. Annotation \textcircled{4} is peak efficiency of the antenna in an embodiment of the disclosure, and a value of the peak efficiency is −4.1 dBi (dBi is a unit for representing an antenna gain). Compared with the existing frame antenna, the antenna in an embodiment of the disclosure has a gain increased by approximate 0.2 dBi.

Moreover, by the antenna provided in embodiments of the disclosure, a total length of a frame antenna of the first middle frame 101 is increased by the middle section 53 of the first metal connection arm 5 such that more antennas can be arranged at the position of the first middle frame 101, or a length of an antenna formed by a single metal frame radiation section 3-1 is increased to be suitable for radiation of a medium-low-frequency electrical signal. In this way, an antenna connected to a radio frequency signal of the mainboard 4 can be arranged at only the position of the first middle frame 101. Thus, a use demand for a foldable electronic device can be satisfied, and an antenna connected to a radio frequency signal of the mainboard is not required to be arranged at the position of the second middle frame 102. A flexible transmission line passing through the rotation shaft 103 in the prior art is canceled. Thus, a structure of the foldable electronic device is simplified, and a thickness of the foldable electronic device can be reduced. Moreover, available space in the middle frame 100A is increased, and structures or layouts of other parts can be optimized advantageously. For example, a battery capacity is increased. The quality of the entire device is further improved, and use cost of the foldable electronic device can be reduced.

For example, all the first metal connection arms 3-1 having transmitting functions of the foldable electronic device are centrally arranged in the first middle frame 101. The mainboard 4 includes M radio frequency circuits configured to provide radio frequency signals to the first metal connection arms 3-1. The mainboard 4 is arranged in the first middle frame 101. Specifically, M is an integer greater than or equal to 1.

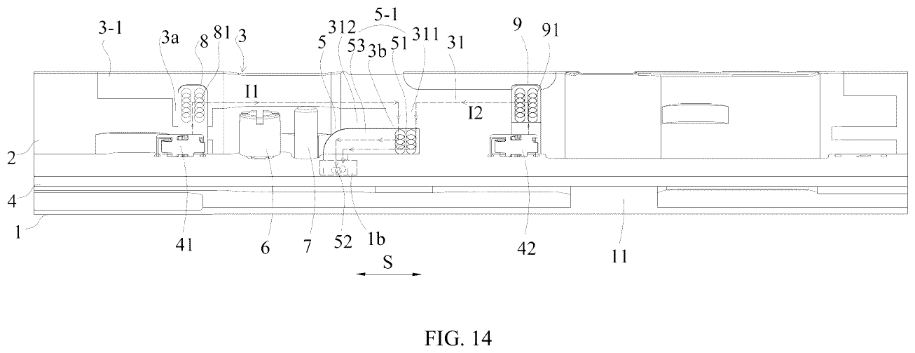

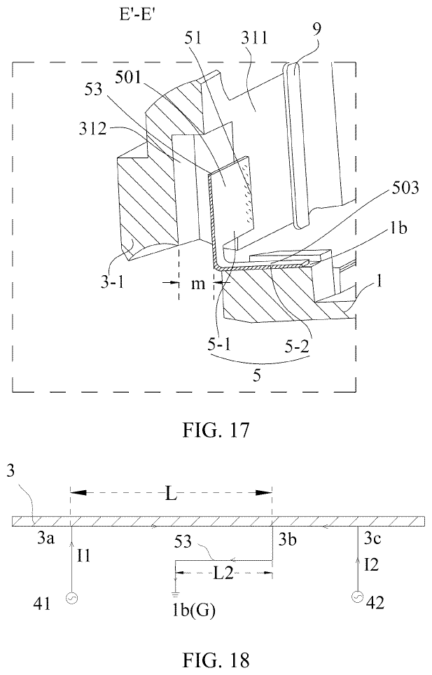

FIG. 14 to FIG. 17 show another embodiment of a schematic partial view of an electronic device according to the disclosure. Positions of the structures shown in FIG. 14 and FIG. 7 in the electronic device are approximately the same. Main differences between the structure shown in FIG. 14 and the structure shown in FIG. 7 lie in that the metal frame radiation section 3-1 in the embodiment shown in FIG. 14 is further provided with a third connection position 3c. The antenna further includes a second metal connection arm 9. The third connection position 3c is electrically connected to a second feed terminal 42 of the mainboard 4 by the second metal connection arm 9. The second feed terminal 42 is configured to be electrically connected to a second radio frequency circuit or a second modulation and demodulation circuit arranged in the mainboard 4. A partial section 91 of the second metal connection arm 9 is welded and connected to the third connection position 3. The partial section of the second metal connection arm and the third connection position are integrally formed through welding. The connection reliability is relatively high The second metal connection arm 9 may elastically abut against the second feed terminal 42 for an electric connection. The second metal connection arm 9 may be in a form of a metal elastic sheet. The structure of the first feed terminal 41 may be the same as the structure of the second feed terminal 42. A frequency of an electrical signal loaded by the first radio frequency circuit may be the same as or certainly may be different from a frequency of an electrical signal loaded by the second radio frequency circuit.

It can be understood in combination with FIG. 18 that in an embodiment of the disclosure, the metal frame radiation section 3-1 of the antenna may be configured to form two current circuits: a first current circuit and a second current circuit. A direction of a current I1 of the first current circuit is as follows: 41-3a-3b-53-1b. A direction of a current I2 of the second current circuit is as follows: 42-3c-3b-53-1b. The first radio frequency circuit and the second radio frequency circuit may load electrical signals having different frequencies. The first radio frequency circuit and the second radio frequency circuit may be turned on at different time or controlled through other methods such that the metal frame radiation section 3-1 can radiate different electrical signals. Different functional requirements of the electronic device can be satisfied.

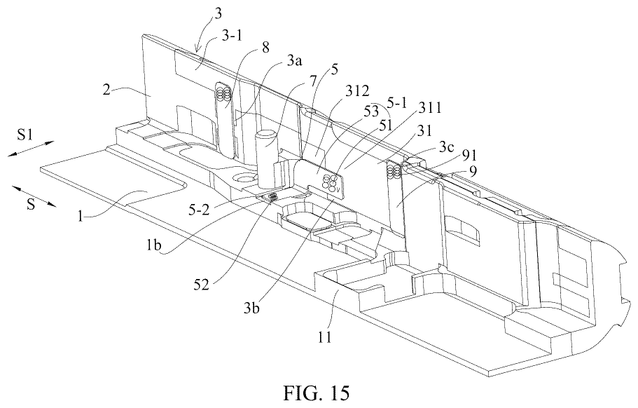

It can be understood in combination with FIG. 15 to FIG. 18 that in an embodiment of the disclosure, the ground terminal 1b may be located between the first feed terminal 41 and the second feed terminal 42. The first connection position 3a, the second connection position 3b, and the third connection position 3c are sequentially arranged in the length direction S of the metal frame radiation section 3-1. It can be seen from FIG. 18 that when the first metal connection arm 5 is connected to the ground terminal 1b and the metal frame radiation section 3-1, a path of the first current circuit becomes longer, and a path change of the second current circuit is not affected. That is, a total length of a radiation antenna formed by the metal frame radiation section 3-1 and the second radio frequency circuit is approximately maintained unchanged. Thus, a use demand for a particular environment can be satisfied, and use flexibility is relatively high.

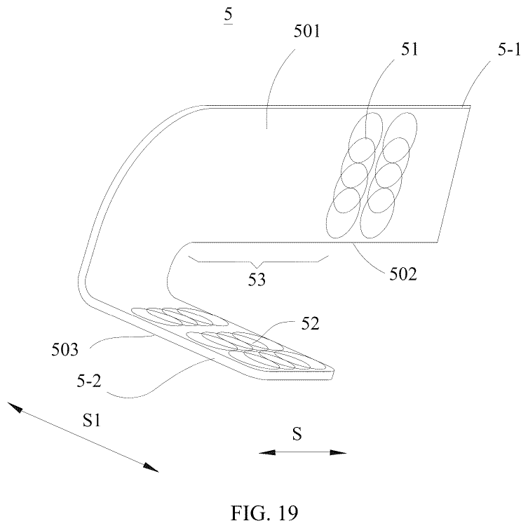

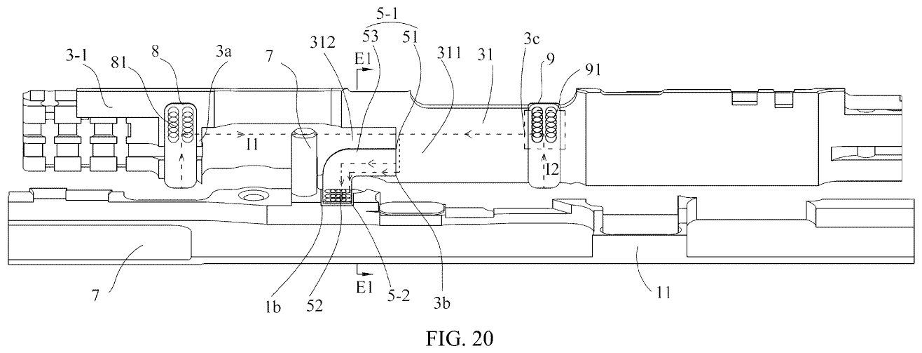

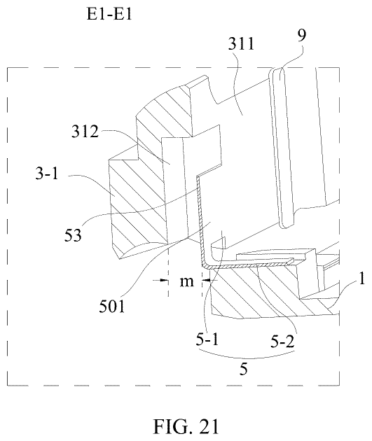

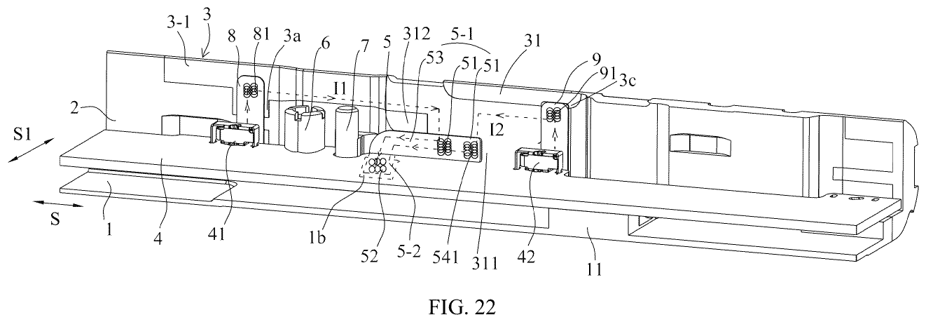

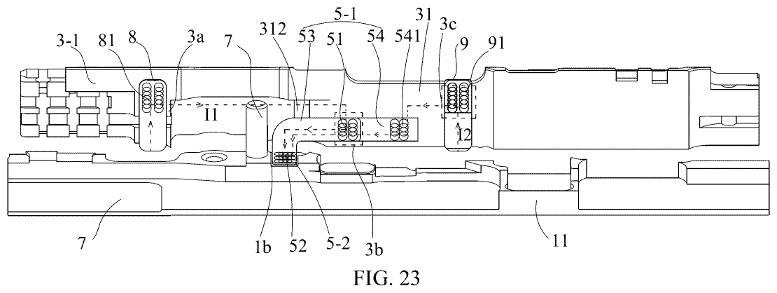

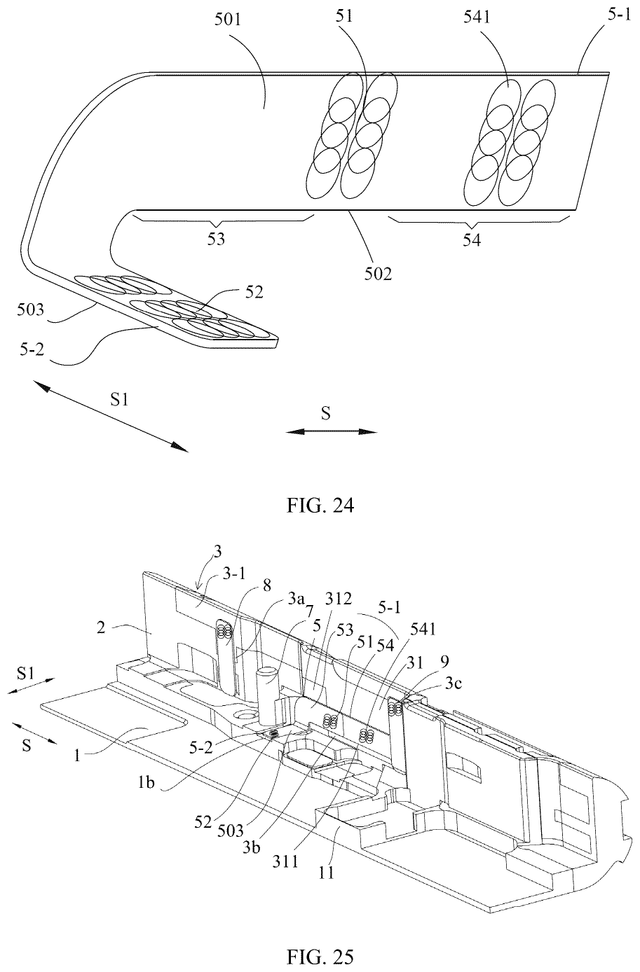

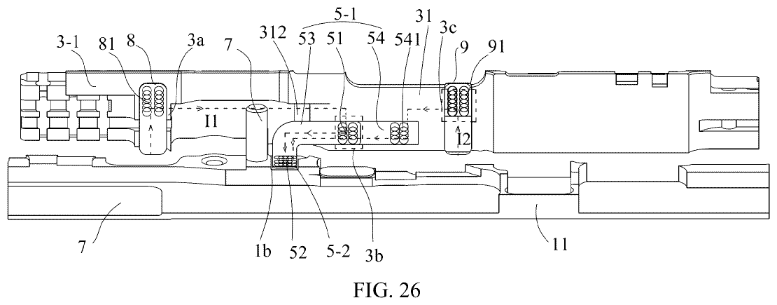

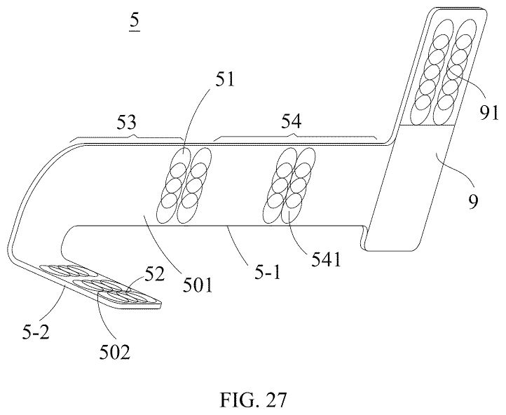

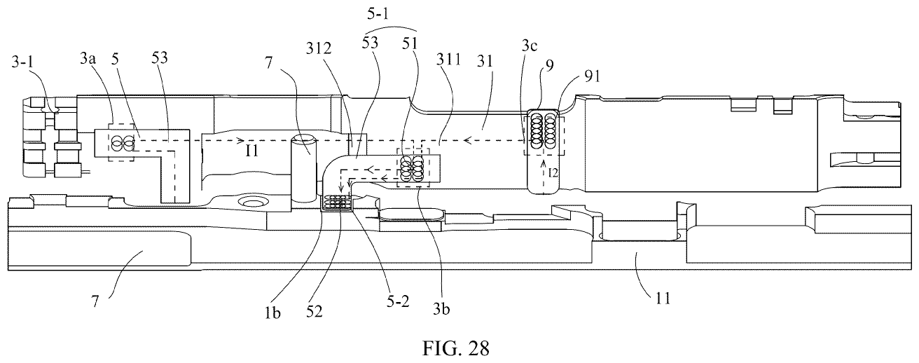

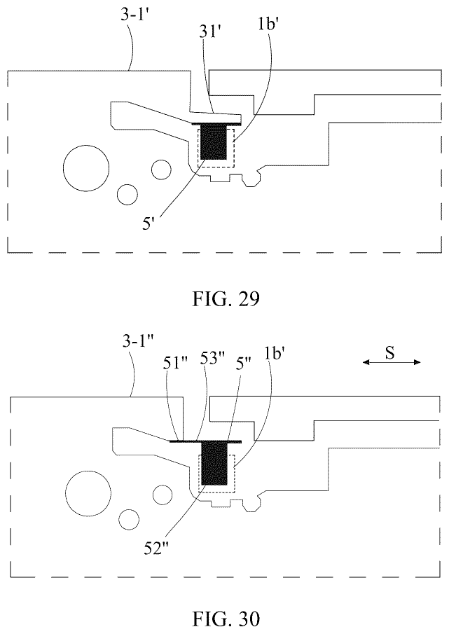

Specific structures of the first metal connection arm 5 in embodiments shown in FIG. 7 to FIG. 18 may be understood in combination with FIG. 19.

With reference to FIG. 20 and FIG. 21, the disclosure further provides yet another embodiment of a partial structure of an electronic device. Compared with the two embodiments shown in FIG. 7 and FIG. 14, the antennas shown in FIG. 20 and FIG. 21 have main differences as follows: the first metal connection arm 5 and the metal frame radiation section 3-1 are integrally formed. Compared with two components that are separately formed and fixed through welding, two components in embodiments of the disclosure that are integrally formed can simplify assembly steps of the electronic device.

It can be understood in combination with FIG. 22 to FIG. 24 that an embodiment of the disclosure further provides yet another particular embodiment of a partial structure of an electronic device. The positions of the structure shown in FIG. 22 and the structure shown in FIG. 7 in the electronic device are approximately the same. In an embodiment of the disclosure, to improve fixation reliability of the first metal connection arm 5, the first board body 5-1 may further include a positioning section 54. The positioning section 54 is connected to a side of the first connection portion 51 away from the middle section 53. At least a partial position of the positioning section 54 is connected to and fixed to the side wall 31 of the metal frame radiation section 3-1. The positioning section 54 has a welding region 541. The welding region 541 is welded and fixed to the side wall 31.

With reference to FIG. 25, FIG. 26, and FIG. 27, an embodiment of the disclosure further provides yet another particular embodiment of a partial structure of an electronic device. In an embodiment of the disclosure, the first metal connection arm 5 is connected and fixed to the second metal connection arm 9. The first metal connection arm 5 and the second metal connection arm 9 may both be independent components, and are fixed through a welding process, an adhesion process, etc. The first metal connection arm 5 and the second metal connection arm 9 as independent components may be separately machined. A machining process is relatively simple.

Certainly, the first metal connection arm 5 and the second metal connection arm 9 may be of an integrated structure, and are integrally formed through stamping and other methods. A mounting operation of the integrally formed structure is simple.

With reference to FIG. 25 and FIG. 26 again, in an embodiment in which the first metal connection arm 5 and the second metal connection arm 9 are integrally formed, a section of the first metal connection arm 5 located between the third connection position 3c and the first connection portion 51 is further connected and fixed to the metal frame radiation section 3-1. A section of the metal frame radiation section 3-1 located between the third connection position 3c and the first connection portion 51 is a positioning section 54. The positioning section 54 mainly has functions of a fixed connection and current conduction, and may not be used as an antenna radiation section. The figure shows a welding region 541 of the first metal connection arm 5 welded and fixed to the metal frame radiation section 3-1.

In an embodiment of the disclosure, the third connection position 3c and the second feed terminal 42 may be arranged in a direction perpendicular to the thickness direction of the mainboard 4. The second metal connection arm 9 may be a mainboard of a straight board structure. Thus, relatively small space is occupied, and the structure of the electronic device is compact advantageously.

In an embodiment of the disclosure, the first metal connection arm 5 may be in a form of a metal elastic sheet plate. The metal elastic sheet plate has a simple structure and occupies small space. Moreover, two connection positions are elastically connected to each other, such that a buffer effect is achieved. Thus, an impact of an external force on the connection positions can be reduced, and connection reliability at the connection positions can be ensured.

In an embodiment of the disclosure, the first connection portion 51 may be welded and fixedly connected to the second connection position 3b. The second connection portion 52 is welded and fixedly connected to the ground terminal 1b.

With reference to FIG. 19, FIG. 20, FIG. 23, and FIG. 26, in an embodiment of the disclosure, the first metal connection arm 5 includes a first board body 5-1, and has a predetermined length in a length direction S of the metal frame radiation section 3-1. A board surface 501 of the first board body 5-1 is arranged opposite the side wall 31. The first board body 5-1 includes a middle section 53 and a first connection portion 51. The first connection portion 51 is located on a side of the middle section 53 away from the ground terminal 1b. In an embodiment of the disclosure, the board surface 501 of the first board body 5-1 is opposite the side wall 31 and extends in the length direction of the metal frame radiation section 3-1. In this way, the first metal connection arm 5 occupies relatively small space in the direction S1, such that a size of the electronic device in the direction is reduced.

With reference to FIG. 9, FIG. 19, FIG. 20, FIG. 23, and FIG. 26 again, in an embodiment of the disclosure, an end of the first board body 5-1 away from the first connection portion 51 has a second board body 5-2. The second board body 5-2 is bent toward a side of the mainboard 4. The second connection portion 52 is located on the second board body 5-2. The second board body 5-2 may be approximately perpendicular to the first board body 5-1. In an embodiment of the disclosure, the second connection portion 52 of the second board body 5-2 is connected to the ground terminal 1b of the middle metal plate 1 located below the mainboard 4. A board surface 503 of the second board body may be approximately arranged parallel to a board surface of the mainboard 4. In this way, a height occupied by the second board body 5-2 on the electronic device is small such that the second board body can be favorably inserted into a position below the mainboard 4 to be welded and fixed to the ground terminal 1b of the middle metal plate 1. In an embodiment of the disclosure, the second board body 5-2 is connected to a side edge of the first board body 5-1 that extends in a length direction S of the metal frame radiation section 3-1. A board surface 503 of the second board body makes contact with the first feed terminal 41 or the ground terminal 1b for an electric connection. After the second board body 5-2 is bent, the board surface 503 of the second board body makes contact with the ground terminal 1b. Thus, space occupied in a thickness direction of the electronic device can be reduced, and an ultra-thin design concept of the electronic device can be satisfied.

In a case that the electronic device is a foldable electronic device, the metal frame radiation section 3-1 and the first feed terminal 41 and the ground terminal 1b that are electrically connected to the metal frame radiation section 3-1 can be located on a same side of the rotation shaft. The structure is simple and compact, and no special flexible transmission line is required to span a region of the rotation shaft 103. Thus, cost can be reduced and space occupied can be reduced.

The above embodiments of the disclosure are all technical solutions introduced with an example in which the first metal connection arm 5 of the above structure is arranged between the second connection position 3b and the ground terminal 1b. A person skilled in the art should understand that the first metal connection arm 5 of the above structure may be arranged between the first connection position 3a and the first feed terminal 41, shown in FIG. 28.

It should be noted that fixed connection positions in FIG. 7 to FIG. 28 are all identified by a plurality of small circles.

Certainly, in an embodiment of the disclosure, the antenna formed by the metal frame radiation section 3-1 and the first metal connection arm 5 is also suitable for a non-foldable electronic device. Thus, an arrangement of a frame antenna of the non-foldable electronic device can be optimized, requirements of a plurality of radiation frequency bands can be satisfied, use functions of the electronic device can be increased, and the quality of the entire device can be improved. In a case of a non-foldable electronic device, one middle frame 100A is arranged. In the disclosure, no figure in which an antenna is arranged in a non-foldable electronic device is provided. However, a person skilled in the art can still apply the above antenna to the non-foldable electronic device.

In addition, another implementation of the antenna is provided below.

With reference to FIG. 29, another schematic structural diagram of a frame antenna in the prior art is shown in FIG. 29. In some application environments, due to layout or structural limitations, the ground terminal 1b′ is relatively far away from the position of the metal frame radiation section 3-1′. A small branch 31′ is required to be arranged in the metal frame radiation section 3-1′. A free terminal of the small branch 31′ can extend to a position near the ground terminal 1b′. A connection elastic sheet 5′ is fixed to the free terminal of the small branch 31′. The connection elastic sheet 5 mainly configured to electrically connect the small branch 31′ and the ground terminal 1b′. In this structure, the metal frame radiation section 3-1′ has a complex structure. The small branch node 31′ has relatively small use intensity, and is likely to be broken.

With reference to FIG. 30, a schematic partial view of an antenna according to an embodiment of the disclosure is shown in FIG. 30. In an embodiment of the disclosure, the first connection portion 51″ and the second connection portion 52″ of the first metal connection arm 5″ are spaced apart from each other in the length direction of the metal frame radiation section 3-1″. The first connection portion 51″ is fixedly connected to the metal frame radiation section 3-1″. The second connection portion 52″ extends to a position near the ground terminal 1b′ through an action of the length of the middle section 53″. That is, the middle section 53″ can replace the small branch. Thus, the structure of the middle frame is simplified, and use intensity is improved.

Certainly, the antenna shown in FIG. 30 may be used as a passive antenna, or certainly may be used as an active antenna. A use environment is not limited, as long as the above technical effects can be achieved.

Other structures of the electronic device can be obtained with reference to the prior art.

In an embodiment of the disclosure, the terms “first” and “second” are used merely for the purpose of description, and should not be construed as indicating or implying relative importance or implying a quantity of indicated technical features. Thus, a feature defined by “first” or “second” may explicitly or implicitly include one or more of the features.

The orientation terms mentioned in embodiments of the disclosure, such as “in” and “outside”, are merely directions with reference to the accompanying drawings. Thus, the orientation terms used are intended to describe and understand embodiments of the disclosure better and more clearly, are not intended to indicate or imply that the indicated apparatus or element is required to have a specific orientation and be constructed and operated in the specific orientation, and thus cannot be construed as limitations to embodiments of the disclosure.

In the descriptions of embodiments of the disclosure, terms “include”, “comprise”, and their variants are intended to cover a non-exclusive inclusion. Thus, a process, method, object, or apparatus that includes a series of elements not only includes such elements, but also includes other elements not specified expressly, or may include inherent elements of the process, method, object, or apparatus.

In embodiments of the disclosure, the term “and/or” describing an association relationship between associated objects indicates that there can be three relationships. For example, A and/or B can represent A alone, both A and B, and B alone. In addition, the character “/” herein generally indicates an “or” relationship between the associated objects.

The above implementations are merely preferred implementations of the disclosure. It should be noted that those of ordinary skill in the art can further make several improvements and modifications without departing from a principle of the disclosure. These improvements and modifications should also be regarded as falling within the protection scope of the disclosure.

What is claimed is:

1. An electronic device, comprising:
a first feed terminal and a ground terminal;
a middle frame, wherein the middle frame comprises a metal frame radiation section, and the metal frame radiation section has a first connection position and a second connection position that are configured to be electrically connected to the first feed terminal and the ground terminal respectively; and
a first metal connection arm, wherein both of at least one group of the first connection position and the first feed terminal, and the second connection position and the ground terminal are electrically connected to each other by the first metal connection arm, and the first metal connection arm has a middle section arranged with a clearance between the middle section and a peripheral metal body.

2. The electronic device according to claim 1, wherein the first connection position and the second connection position are spaced apart from each other in a length direction of the metal frame radiation section, and at least a part of a projection of the middle section on the metal frame radiation section is located between the first connection position and the second connection position.

3. The electronic device according to claim 2, wherein an extension direction of the middle section is consistent with the length direction of the metal frame radiation section.

4. The electronic device according to claim 3, wherein the middle frame comprises an accommodation cavity; and
the metal frame radiation section comprises a side wall facing the accommodation cavity, the side wall comprises a first surface and a second surface, the second surface is recessed relative to the first surface towards a side away from the accommodation cavity, a clearance is provided between the middle section and the second surface, and the first metal connection arm makes contact with and is electrically connected to the first surface.

5. The electronic device according to claim 4, wherein the first metal connection arm comprises a first board body, the first board body has a predetermined length in the length direction of the metal frame radiation section, a board surface of the first board body is arranged opposite the side wall, the first board body comprises the middle section and a first connection portion that makes contact with and is electrically connected to the first surface, and the first connection portion is located on a side of the middle section away from the ground terminal.

6. The electronic device according to claim 5, wherein an end of the middle section away from the first connection portion has a second board body, the second board body is bent towards a side of the accommodation cavity, and the second board body has a second connection portion electrically connected to the ground terminal.

7. The electronic device according to claim 6, further comprising: a mainboard arranged in the accommodation cavity, wherein a board surface of the second board body is opposite a board surface of the mainboard, and the board surface of the second board body makes contact with and is electrically connected to the ground terminal.

8. The electronic device according to claim 5, wherein the first board body further comprises a positioning section, the positioning section is connected to a side of the first connection portion away from the middle section, and the positioning section is connected and fixed to the side wall of the metal frame radiation section.

9. The electronic device according to claim 1, wherein the first metal connection arm is connected between the ground terminal and the second connection position, the metal frame radiation section is further provided with a third connection position, the first connection position, the second connection position, and the third connection position are sequentially arranged in an extension direction of the metal frame radiation section, the electronic device further comprises a second feed terminal, the ground terminal is located between the first feed terminal and the second feed terminal, the electronic device further comprises a second metal connection arm, and the third connection position is electrically connected to the second feed terminal by the second metal connection arm.

10. The electronic device according to claim 9, wherein the first metal connection arm is connected and fixed to the second metal connection arm, or the first metal connection arm and the second metal connection arm are of an integrated structure.

11. The electronic device according to claim 10, wherein the first metal connection arm comprises a positioning section, the positioning section is connected to a side of the first connection portion away from the middle section and extends and is connected to the second metal connection arm, and the positioning section is connected and fixed to the metal frame radiation section.

12. The electronic device according to claim 9, wherein the first metal connection arm is welded and fixed to the metal frame radiation section, and the second metal connection arm is welded and fixed to the metal frame radiation section.

13. The electronic device according to claim 9, wherein the first metal connection arm is elastically and electrically connected to the first feed terminal, and the second metal connection arm is elastically and electrically connected to the second feed terminal.

14. The electronic device according to claim 1, wherein the middle frame comprises a metal frame and a middle metal plate, the metal frame is located on an outer periphery of the middle metal plate, the metal frame radiation section is a partial section of the metal frame, the ground terminal is arranged at the middle metal plate, the electronic device comprises the mainboard, and the ground terminal is electrically connected to a ground position of the mainboard.

15. The electronic device according to claim 14, wherein the middle frame further comprises a plastic body, and the metal frame and the middle metal plate are integrally connected to each other by the plastic body.

16. The electronic device according to claim 1, wherein the middle frame comprises N sides sequentially connected, the metal frame radiation section is located on only one side, or the metal frame radiation section is located on two adjacent sides, and N is an integer greater than or equal to 2.

17. The electronic device according to claim 1, wherein the electronic device is a foldable electronic device, the middle frame comprises a first middle frame and a second middle frame, the foldable electronic device further comprises a rotation shaft, the first middle frame and the second middle frame are rotatably connected to two sides of the rotation shaft respectively.

18. The electronic device according to claim 17, wherein at least one of the first middle frame and the second middle frame has the metal frame radiation section, and each metal frame radiation section and the first feed terminal and the ground terminal that are electrically connected to the metal frame radiation section are all located on a same side of the rotation shaft.

19. The electronic device according to claim 18, wherein the foldable electronic device further comprises the mainboard, the mainboard is located in the first middle frame, and all metal frame radiation sections that have transmitting functions are centrally arranged in the first middle frame.

20. The electronic device according to claim 19, wherein the second middle frame has at least one metal frame radiation section, and the metal frame radiation section located in the second middle frame has only modulation and/or demodulation functions.
